(19) United States
(12) Patent Application Publication
(10) Pub. No.: US 2019/0191724 A1
(43) Pub. Date: Jun. 27, 2019

(54) Microwaveable Frozen Breads and Method of Making The Same

(71) Applicant: Rongxuan Cai, Sioux Falls, SD (US)

(72) Inventor: Rongxuan Cai, Sioux Falls, SD (US)

(21) Appl. No.: 15/855,640

(22) Filed: Dec. 27, 2017

(51) Int. Cl. A21D 10/02; A21D 6/00; A21D 17/00; A21D 13/32

(52) U.S. Cl. CPC A21D 10/02; A21D 13/32; A21D 17/006; A21D 6/001

(57) ABSTRACT

The present invention discloses a microwaveable frozen bakery that has a more appealing color, fresher aroma and a softer inner texture compared to products of prior art when prepared using a microwave oven for final cooking before consumption. The product has a sealed golden brown colored skin with a baked appearance but without the large amounts of moisture loss during preparation compared to its baked product counterpart, rendering a higher moisture preservation in the bakery. When microwave cooked, the high moisture crumb and sealed skin compensate or prevent moisture loss and produces a softer bread texture. Method of preparation comprises mixing a dough composed of flour, water, yeast and other additives, portioning and making up the dough, fermenting, proofing, steaming, and quickly baking the dough at high heat oven, where a sealed golden brown colored skin and a high moisture crumb are developed, and freezing the bakery.

### FIELD

The present invention relates to microwaveable frozen bakery products. In particular, the present invention relates to frozen baked good that has a sealed golden brown colored skin and a higher inner moisture content than a counterpart bakery product. The present invention further relates a microwaveable bakery product that has an appealing golden-brown color and a softer texture after microwave oven cooking.

### BACKGROUND

Microwave cooking has been a method of choice for its convenience. Meals can be cooked in a matter of a few minutes when a microwave oven is used. This is in contrast to using a conventional oven or a boiler for an equivalent meal, which typically require hours. The rapid cooking ability of a microwave oven is attributed to its cooking mechanism, where the dipole molecular spins as well as the ionic migrations generate heat in food. In contrast, when heat is generated through conduction and convection of a heat source, the heat needs to be transported from its generator to the object to be heated, and further transported from the surface to the interior of food. Microwave energy has good penetration ability, making microwave heating rapid and able to occur throughout all locations of food simultaneously. Without a doubt, the microwave has played an important part in people's daily life and touches the majority of households in the USA.

While the cooking mechanism makes the microwave energy efficient and gain speed in heating, it also makes a food lose moisture quickly. The microwave directly acts upon water molecules to generate heat, making the vapor of water moving outward. Unlike conventional baking, microwave cooking does not develop a brown surface, for example, there is no crust for a bakery, and there is no sealed skin from a microwaved bakery. The disadvantage of excessive moisture loss results in a dry or tough texture that is often seen in many food products, especially bakery products. A bagel could be burnt in minutes in a microwave oven; a bun could dry out and to be too tough to eat when heated at a high temperature or for a long time in a microwave oven. To avoid over-heating, a bakery can be just warmed up for a short time, but it will not be hot enough to develop a freshly heated aroma when heated at low temperature or for a short time. Similar situations exist with other baked products, including breads, dinner roll, croissants, flatbreads, and the like. In addition, color development is not possible because of the lack of the conditions for a browning reaction in the surface of food. Food browning during baking is mainly a result of the Maillard reaction, which occurs between an amino acid and a reducing sugar. The reaction requires at a temperature above 165° F. and a dry material to occur. Consequently, foods from microwave cooking often show a lack of desired texture (either soggy or too tough), and the lack of an appealing color. In addition, the food also shows a lack of aroma because the microwave heating cannot be high enough for aroma development due to excessive moisture loss with high microwave heating.

Among many microwave challenges, one of the most significant disadvantages is the excessive loss of moisture during microwave cooking, which causes the loss of freshness of the product after microwave preparation. The cause of excessive moisture loss results from mechanisms of microwave cooking where microwave energy is preferentially absorbed by substances with a high dielectric constant. Water is such a substance and receives high heat and become readily volatile in the food. The loss of moisture in a food causes hardening of the product and increases staling. Hence, a product that can prevent or compensate for moisture loss during microwave cooking will enhance freshness and maintain product quality. If moisture is available, a microwave can be used as a deep cooking tool for such frozen food preparation, and not just as an assisted warm-up tool for such food. It is, therefore, necessary to develop a process and product that will overcome moisture loss and maintain freshness during microwave cooking. Additionally, it is desirable to develop technologies that can develop a golden brown colored skin while maintaining a high moisture content during baking.

Pressurized steaming was known to the prior art as a baking aid to remove bread acid (U.S. Pat. No. 666,216, 1901). In that patent, a proofed dough was steamed for about one hour and then baked to the extent of being fully baked, resulting in a bread with a similar texture nearly to one from a conventional one step baking. In the method, moisture is added during steaming but consequently is removed during the baking. Therefore, the moisture is not preserved for microwave loss. The process makes the bread more readily digested when eaten because of the steam treatment with changes to the end product texture. Steams have also been used to assist in baking to improve bakery quality and performance by either helping add moisture or seal the skin of dough product during baking (U.S. Pat. No. 4,861,601, 1989; U.S. Pat. No. 6,629,493, 2003, U.S. Pat. No. 7,745,763 2010). In the 1989 U.S. Pat. No. 4,861,601 granted to Seneau, a first and second steam are injected into the oven during pre-baking of the bread. These steam injections introduce moisture into the product and cause the formation of a skin sealing the product so as to secure the crust and prevent it from separating from the loaf of crumb. However, brief steams by themselves will have little actions upon the protein and starch conformational changes, and will not provide the amount of moisture addition necessary to compensate the microwave loss when microwave is used as a final baking method. In the 2003 U.S. Pat. No. 6,629,493 granted to Schaible II et al., the patent describes a process which employs an apparatus for pizza crust made with steam injection as baking aids. The proofed pizza crust dough is treated in a steam bath tunnel for about 35 seconds where steams are injected into the tunnel at a pressure of 35-45 psi. Dough is hydrated before baking and, therefore, the crust has an improved hydration of 38-40% even after finished par-baking. In this case, again the steams are injected and used for enhancement in hydration as aid to assist baking performance. In the U.S. Patent, steam injections are again different from actual steaming and have limited impact on protein and starch conformational changes and moisture addition to the product. In the 2010 U.S. Pat. No. 7,745,763 granted to Fraccon, S. et al, a baking method using steam was introduced and applied in an automatic household baking oven. The oven is equipped with a steam injection system that can provide steam into the baking cavity during baking. In both cases, brief steam injections are used as baking aids to improve bakery performance. Typically, brief steam injections are not sufficient conditions to cause starch gelatinization and protein denaturation. Steaming to the full extent of a cooked product will serve the purpose of gelatinizing the starch and denaturing the proteins. In a 1994 European Patent Application (EP 0620975 A2), Improved microwaveability of baked products, by Mao et al., steam was used to produce bagels for end preparation by microwave cooking. The use of steam adds moisture and causes protein and starch conformational change for consumption. When the product is microwaved at the point of consumption, the added moisture compensates for the excessive loss during microwave cooking. However, steaming alone develops a light skin product that does not resemble the baked color and a match of the color by a colorant is difficult and not a true baked color.

Consequently, there is a need for additional methods that can provide a product overcoming the toughness and color development issues with microwaved food.

### SUMMARY OF THE INVENTION

This invention discloses a microwaveable frozen dough product that possesses a dry skin film with a dark, golden-brown surface color yet a higher interior moisture content than that of dough products prepared by a conventional oven. The high interior moisture content provides a source of moisture to compensate for microwave loss and, therefore, the product is maintained in a fresh and soft texture and has an interior moisture content similar to that of an oven baked product. The high interior moisture content permits microwave cooking at a high temperature in a relatively longer time than when the interior moisture content is similar to the baked good without the addition of moisture by steaming. This high temperature and longer microwaving allow the product to be fully reheated and, bring out the aroma and freshness of the product at the time of consumption. The dry skin film also provide protection against moisture loss during microwaving and turns to an appealing brown colored surface after microwaving because of the moisture migration. The product is prepared by steaming a fermented bread dough and baking the steamed dough at high heat for a very short time. The steaming step adds moisture throughout the dough while the baking step causes a quick reaction on the surface of dough but little moisture loss during baking. The product was then cooled down to room temperature, and stored at −10° F. until use. When ready for consumption, the product is microwaved for 1.5 to 3.5 min to result in a bread product with a golden brown color and freshness due to the moisture migration to the very dry surface and a soft texture.

### BRIEF DESCRIPTION OF DRAWINGS

FIG. 1 shows the moisture loss at different stages of the product in Example 1.

FIG. 2 shows moisture the content of the end product after microwave cooking of products in Example 1.

FIG. 3 shows a light-colored bread after steaming (steamed bread) for products of Example 1.

FIG. 4 shows a dark golden brown colored bread after steaming followed by a high heat quick baking for products of Example 1.

### DETAILED DESCRIPTION

It was discovered that using steam in conjunction with high heat and short baking time provides a solution to the moisture and color issues with the microwaved product. This combined treatment provides the bread dough with a higher interior moisture content to compensate for moisture loss during microwave cooking, and, at the same time, also creates a sealed golden-brown crust that serves the color of a baked good while preventing excessive moisture loss during microwave cooking.

It is based on the mentioned observation of moisture loss, color issue with microwaving mechanism that the current invention was conceived and experimental tests were conducted. The process in the present invention adds and maintains moisture inside of the product and, therefore, the freshness to the end product. Firstly, the product was steamed, which adds extra moisture to the product to compensate for microwave loss. Secondly, the high heat and short baking time creates a sealed golden brown colored skin, which resolves the pale color issue with microwaved products. And, thirdly, the sealed skin further prevents moisture loss during microwave cooking. Additionally, the product is perceived fresher since a high heat can be applied using microwave cooking.

The present invention provides a microwaveable frozen bread that can avoid issues associated with microwaved products where a tough texture, the lack of fresh aroma development and lack of color development are often encountered. The objective of the present invention is achieved by the addition of several elements to the frozen dough product. The present invention resolves the toughness issue and the lack of fresh aroma issues by adding additional moisture to the bakery to compensate for the excessive moisture loss during microwaving. Because more water is available to compensate for water loss, more water is retained after microwaving. Also because more water is available to compensate for loss, a higher oven power and longer heating time are allowed during microwaving, rendering the development of fresh aromas at the conclusion of food preparation. The present invention resolves the issue with the lack of color development by a high heat and short time baking step prior to frozen storage of the bakery products. The microwaveable frozen dough products possess a dry skin film with a dark golden-brown surface color and a higher interior moisture content than that of bread baked by a conventional oven. In addition to a golden-brown color, the sealed golden brown colored skin film also provides protection against moisture loss and serves as a receptor for moisture migration from the interior, which creates an appealing golden-brown color after microwaving.

More specifically, several product advantages are demonstrated with the current invention. The product is able to maintain a fresh texture and a high moisture content in the bread after microwaving because the steaming step that adds moisture to the product to compensate for moisture loss during microwave cooking and the sealed golden browned skin that provides protection against moisture loss. The product is able to maintain a fresh texture because the steaming step that provides the heat and moisture conditions for the macromolecules to rearrange through protein denaturation and starch gelatinization. The product is able to provide a rich flavor by heating the product to over 200° F. for sufficient time without getting tough. The product is able to produce a golden brown color yet not lose interior moisture because of the use of a high heat short time baking step on a steamed dough. The product is able to provide a crispy bottom and top surface and a tender inside after microwaving with a regular pouch type susceptor.

The frozen microwaveable product is ready to microwave as a final method of preparation before consumption. The product possesses a dark golden brown exterior color and a high interior moisture designed to be further heated by a method of microwave energy. During the final food preparation using microwave cooking, the loss of moisture lowers the interior moisture content to a level similar to the freshly baked bread from raw dough, and the moisture migration from the interior to exterior makes the dry skin become moisturized and appealing in combination with the golden brown color.

The methods of the present invention can be used for common bakery products, including but not limited to bread, buns, rolls, sandwiches, pound bread, mini bread, flat bread, bagels, croissants, ciabatta, focaccia, and the like.

White refined wheat flour and whole grain wheat flour can be used to prepare the products of present invention. Grains other than wheat can also be used. Examples of common grains include wheat, oat, barley, rye, rice, corn, quinoa, millet, sorghum, triticale, amaranth, and buckwheat. Both gluten flour, including wheat, barley, rye and gluten free flour can be used. Examples of common gluten free flour are oat, rice, corn, quinoa, millet, sorghum, triticale, amaranth, and buckwheat. Ancient grains can also be used. Example of ancient grains include einkorn, kamut, spelt, black barley, red and black rice, blue corn; sorghum, teff, millet, quinoa, amaranth; buckwheat, or wild rice.

Various yeasts can be used for preparation of the frozen dough products using embodiments of present inventions. Commonly used yeasts include cream yeast (moisture content about 82%), compressed yeast (moisture content about 35%), frozen yeast (moisture content about 20%), active dry yeast (moisture content about 7%), instant yeast (moisture about 5%). Although various yeasts differ in moisture content and the granular form, all yeasts can be used in preparation of the frozen dough products.

The embodiments of the present invention combine a steaming and a high heat short time baking step. The process of the present invention first uses a steaming step to cook a proofed dough, followed by high heat and shot time baking. Steaming is a process that prepares the food using steam as a means of cooking. During steaming, water vapor at a temperature of around 212° F. and at a pressure of around 1 atm is applied to food. When sufficient time is allowed, food is cooked to a full readiness for consumption with proper protein and starch conformational changes. In the present invention, 6-15 minutes of steaming is determined to be sufficient for dough pieces ranging from 100 g to 250 g. Steaming is conducted in a household steam pot with a built-in screen and a lid on top. After steaming, the dough is then transferred to a high heat oven and baked for a short period of time such that the surface of the product develops a golden-brown color yet moisture loss is minimized. Typical conditions of baking are 400-800° F. and 0.5 -5 min. These conditions are found to be enough to develop a golden-brown color without causing excessive loss of moisture in the product. It is expected that some adjustments of baking temperature and time will be necessary for products of different sizes or formulations.

Known prior arts using steam assisted baking either do not add sufficient amounts of moisture or add but subsequently remove moisture using conventional baking. The present invention uses deep steaming in combination with a high heat and short time baking as an aid for microwaveable product, whereby moisture is added while a sealed golden brown colored skin is also developed. The present invention requires a steaming step which needs to provide the conditions for macromolecular conformation rearrangement, and to prepare for further cooking by adding sufficient amounts of moisture to the product. Further treatment include baking and microwaving. The present invention also requires a high heat short time baking step, which develops a brown colored skin for color appealing and for moisture protection. The preparation steps before freezing are necessary steps as microwaving aids, which results in a product with fresh texture and higher moisture content after microwave cooking.

The process of making such a product possessing a dark exterior golden brown color and a higher interior moisture content can be uniquely applied to industrial production. Any industrial steamer and an industrial scale oven can serve the purpose of steaming and baking the product. In addition, a convection oven will be better than a conventional oven since the former will be better at promoting a surface reaction and facilitating the development of surface color while preventing excessive interior moisture losses.

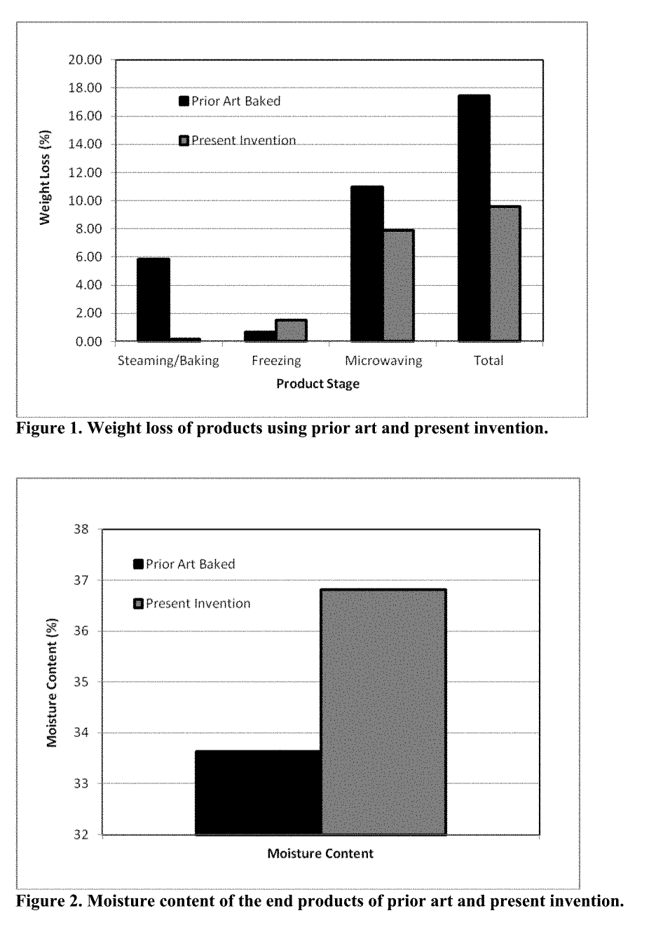

According to the embodiments of the present invention, as shown in FIG. 1 and FIG. 2, the moisture loss during the baking step is compensated by a moisture increase in a steaming step, which decreases the total moisture loss. This results in a total decrease in overall weight loss to 9.6% compared to a total loss of 17.47% of the prior art (FIG. 1). The total moisture content is maintained at 36.7% compared to 33.6% of the prior art after microwave cooking.

It should be appreciated that the descriptions of the embodiments herein are only representatives of the present invention, and are not limiting to applying the principle of the invention to other products and circumstances as demonstrated by the spirit of the invention.

### EXAMPLE 1

A mini bread is prepared according to an embodiment of present invention, and moisture loss, moisture content, and product hardness were compared to product of a prior art. A mini pan bread formula is used in the test and is given in Table 1. Bread of the prior art and present invention are all made from the same formula. Bread of the prior art is baked after proofing whereas bread of the present invention is steamed followed by a quick high heat short time baking.

During the preparation of dough, ingredients were weighed according to Table 1. All dry ingredients, including flour, yeast, salt, sugar whey and non fat dry milk were added to a Kitchen Aid Mixer, malt syrup and shortening was added, and ascorbic acid was added with a small amount of water. The content was mixed for 1 min at low (speed 1). Water was then added to the dry blend in mixing bowl and the content was mixed for approximately 2 min at low speed 2 and 5 min at high speed 4. After mixing, dough temperature was recorded to be about 82° F. The dough was divided to 180 g dough loaves and made to fit into mini bread pans of top 6.0×3.25×2.0 inch and bottom 4.75×2.5×2in (length×width×height). The dough was then transferred into a proofer and proofed at 86° F. and 70% humidity for 2 hours until the dough height is 2-3 cm above the surface of the pan. For control product following the prior art, the product was baked at a conventional oven at 400° F. for 16 min. After weight and volume readings, the products were then frozen and stored at −10° F. until use. For the product of the present invention, after proofing, the dough was transferred manually to a steam pot and steamed for 8 min. The steamed products were then baked at 600° F. for 1.5 min in a convection oven. The products were then stored at −10° F. until use. When ready to consume, the products were taken directly from freezer and microwaved with a pouch type susceptor for 2.5 min for the mini loaf in a 1000W microwave oven.

TABLE 1
Dough Formulation

| Ingredient | Baker's % | Grams |
|---|---|---|
| Hard Wheat Flour | 100 | 1000 |
| Active Dry Yeast | 1 | 10 |
| Shortening | 3 | 30 |
| Salt | 1.5 | 15 |
| Sugar | 6 | 60 |
| Malt Syrup | 0.2 | 2 |
| Whey | 2 | 20 |
| Non Fat Dry Milk | 2 | 20 |
| Ascorbic Acid | 0.002 | 0.02 |
| Water | 59.5 | 595 |
| Total | 175.2 | 1752.02 |

Result of the weight losses through different stage of production is given in Table 2. As can be seen from Table 2. Prior art baking method produced a product with 5.84% weight loss during the baking step. In contrast, the present invention produced a product with a very small amount of weight loss during the steaming and high heat short time baking, only 0.17%. Steaming alone resulted in an increase in weight of 1.13% to the product. A small frozen loss was observed for frozen products of both the present invention and the prior art during frozen storage. After microwave cooking, large amounts of moisture losses were observed. Products from prior art lost 10.97% whereas product of the present invention lost 7.90%. The total moisture loss of the prior art was 17.5%, and that of the present invention was 9.6%. Therefore, the final product of the present invention retains about 8% more water in the bread. Sensory evaluation indicated that the prior art is hard to the touch by finger and tough when eaten, whereas the product of the present invention was softer and with a normal bite as those freshly baked from the conventional oven, as can be seen from the sensory hardness and toughness scores (Table 2). Steaming alone also resulted in a lower total weight loss of 10.19% but a white grey color, unlike a golden-brown color of the present invention (Table 2).

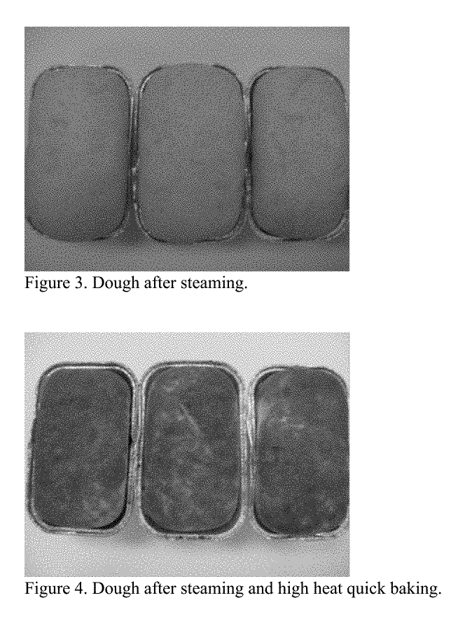

The differences in moisture loss for products of prior art and present invention at different stages of sample preparation are plotted in FIG. 1, and the differences in moisture content of end products are given in FIG. 2. It was observed that the present invention produced a product with a higher moisture content at the end and a softer texture while still possessing a golden brown baked color. As shown in FIG. 3 and FIG. 4, a golden brown colored product was obtained after steaming and high heat quick baking. It was concluded that the present invention preserves moisture in the crumb while developing an appealing color at the final cooking.

TABLE 2
Weight Loss And Sensory Characteristics of Mini Bread Made
of Prior Art and Present Invention (180 g mini loaf)

| | Weight Loss at Various Stage of Production (%) | | | | | | | |
|---|---|---|---|---|---|---|---|---|
| | Loss at | | | | Temp (° F.) | | | |
| | baking | | Loss at | | after | | | |
| | and/or | Loss at | Microwave | Total | Microwave | Sensory Scores (1-5) ^{a} | | |
| | Steaming | Freezer | Cooking | Loss | T (° F.) | Hardness ^{b} | Toughness ^{c} | Color |
| Prior Art, | 5.84 | 0.66 | 10.97 | 17.47 | 213.00 | 5.0 | 5.0 | Golden |
| Baking | | | | | | | | Brown |
| Prior Art, | −1.13 | 1.07 | 10.25 | 10.19 | 207.00 | 2.5 | 2.5 | Grey |
| Steaming | | | | | | | | White |
| Present | 0.17 | 1.53 | 7.90 | 9.60 | 210.00 | 3.0 | 2.5 | Golden |
| Invention | | | | | | | | Brown |

^{a} Sensory scores 1-5 with 1 being the lowest and 5 the highest;
^{b} Hardness is evaluated by a finger touch with the amount of force necessary to deform the bread after leaving the product on the kitchen table for 2 min following the microwave cooking;
^{c} Toughness is evaluated by 2-3 bites to the product after leaving the product on the kitchen table for 2 min following the microwave cooking.

### EXAMPLE 2

A sandwich bun was prepared according to an embodiment of the present invention. The formula and procedures for making the dough are the same as those described in Example 1. After mixing, the dough was divided to 100 g dough pieces, rounded by hand to dough balls, allowed to sit on individual baking papers, and proofed for 2 h at 95° F. and 70% humidity. Control products were prepared by baking at 400° F. for 16 min, whereas products of the present invention were steamed for 6 min and then quick baked at 600° F. for 1 min. The steaming adds moisture to the product and the high heat quick bake procedure develops a golden brown crust without excessive moisture loss. All samples are stored frozen at −10° F. When ready to use, the products were taken directly from freezer and microwaved with a pouch type susceptor for 1.5 min for the buns in a 1000W microwave oven. Weight loss and sensory scores are given in Table 3.

As can be seen from Table 3, the total loss of the prior art is 28.6% and that of the present invention is 20.9%. About 8% water was retained in the product. It was observed that the present invention produced a product which was softer and less chewy compared to the bites with an aroma developed strongly because of a deep microwave cooking to a high temperature. The moisture retention ensures that the needed heating conditions for a fresh aroma will not be hindered by the moisture loss causing the product to be too dry to chew. Steaming alone also resulted in a lower total weight loss of 15.20% but a white grey color, unlike a golden brown color of the present invention (Table 3).

It was concluded that the present invention enables the production of frozen bread buns suitable for microwave cooking without losing the texture and the baked golden-brown color.

TABLE 3
Weight Loss And Sensory Characteristics of Sandwich Buns
Made of Prior Art and Present Invention (100 g bun)

| | Weight Loss at Various Stage of Production (%) | | | | | | | |
|---|---|---|---|---|---|---|---|---|
| | Loss at | | | | Temp (° F.) | | | |
| | baking | | Loss at | | after | | | |
| | and/or | Loss at | Microwave | Total | Microwave | Sensory Scores (1-5) ^{a} | | |
| | Steaming | Freezer | Cooking | Loss | T (° F.) | Hardness ^{b} | Toughness ^{c} | Color |
| Prior Art, | 11.40 | 0.30 | 16.90 | 28.60 | 213 | 5.0 | 5.0 | Golden |
| Baking | | | | | | | | Brown |
| Prior Art, | −2.20 | 2.50 | 14.80 | 15.20 | 216 | 2.5 | 2.5 | Grey |
| Steaming | | | | | | | | White |
| Present | 3.00 | 1.50 | 16.40 | 20.90 | 214 | 3.0 | 2.5 | Golden |
| Invention | | | | | | | | brown |

^{a} Sensory scores 1-5 with 1 being the lowest and 5 the highest;
^{b} Hardness is evaluated by a finger touch with the amount of force necessary to deform the bread after leaving the product on the kitchen table for 2 min following the microwave cooking;
^{c} Toughness is evaluated by 2-3 bites to the product after leaving the product on the kitchen table for 2 min following the microwave cooking.

### EXAMPLE 3

Dough formulation of a hearth bread was made according to an embodiment of the present invention, and bread after microwave cooking was evaluated for moisture loss, hardness and toughness.

A sponge dough was mixed using formulations of Table 4. All ingredients were added into a Kitchen Aid mixer and mixed for 2 min. The dough batter was covered and allowed to ferment at room temperature (70° F.) for 2 h. The sponge was then combined with additional ingredients of flour, year and salt, and used to make the dough. The dough was mixed for 1 min at low speed 2 and then mixed for 7 min at high speed 4. The dough was then divided to 250 g dough loaf and rounded to a hearth bread on a parchment paper. It was then transferred into a proofer and proofed at 86° F. and 70% humidity for about 2 hours. For control product following the prior art, the product was baked in a conventional oven at 400° F. for 26 min. The products were then frozen and stored at −10° F. until use. For the product of present invention, proofed dough was steamed for 8 min and then quick baked at high temperature of 600° F. for a short time of lmin in a convection oven. The products were then stored at —10° F. until use. When ready to consume, the products were taken directly from the freezer and microwaved with a pouch type susceptor for 3.0 min in a 1000W microwave oven.

TABLE 4
Hearth Bread Formula

| | True % | Grams |
|---|---|---|
| Dough Starter (Sponge) | | |
| Hard wheat flour | 24.4 | 350 |
| Instant Active Dry Yeast | 0.10 | 1.4 |
| Honey | 0.84 | 12 |
| water (65° F.) | 39.05 | 560 |
| Flour Blend (Dough) | | |
| Hard Wheat Flour | 34.17 | 490 |
| Instant Active Dry Yeast | 0.20 | 2.8 |
| Salt | 1.26 | 18 |
| Total | 100 | 1434.2 |

Results of the weight loss through different stage of production is given in Table 5. As can be seen from Table 5. Prior art baking method produced a product with 4.67% weight loss during the baking step. The present invention produces the product with a very small amount of weight loss during the steaming and high heat short time baking, only 0.60%. In the microwaving step, larger amount of moisture losses were observed. The product of the prior art using baking lost 8.56% whereas product of the present invention lost 8.51%. The total moisture lost in the prior art was 14.13%, and that of the present invention was 10.21%. Therefore, the final product of the present invention retained about 3.4% more water in the bread. Sensory evaluation indicated that the prior art is harder to the touch by finger and tougher when eaten, whereas the product of the present invention was softer and had a normal bite as those of freshly baked products from the conventional oven without microwave cooking, as can be seen from the sensory hardness and toughness scores. Steaming alone also resulted in a lower total weight loss of 8.66% but a white grey color, unlike a golden brown color of the present invention (Table 5).

It was concluded that the present invention produced a bakery suitable for microwave cooking without excessive losses of moisture and maintained a golden brown color for the product.

TABLE 5
Weight Loss And Sensory Characteristics of Hearth Bread Made of
Prior Art and Present Invention (250 g loaf), microwaved 3 min

| | Weight Loss at Various Stage of Production (%) | | | | | | | |
|---|---|---|---|---|---|---|---|---|
| | Loss at | | | | Temp (° F.) | | | |
| | baking | | Loss at | | after | | | |
| | and/or | Loss at | Microwave | Total | Microwaving | Sensory Scores (1-5) ^{a} | | |
| | Steaming | Freezer | Cooking | Loss | T (° F.) | Hardness ^{b} | Toughness ^{c} | Color |
| Control, | 4.67 | 0.90 | 8.56 | 14.13 | 190 | 5.0 | 5.0 | Golden |
| Baking | | | | | | | | Brown |
| Control, | −1.66 | 1.70 | 8.62 | 8.66 | 175 | 2.5 | 2.5 | Grey |
| Steaming | | | | | | | | White |
| Present | 0.60 | 1.1 | 8.51 | 10.21 | 175 | 3.0 | 2.5 | Golden |
| Invention | | | | | | | | brown |

^{a} Sensory scores 1-5 with 1 being the lowest and 5 the highest;
^{b} Hardness is evaluated by a finger touch with the amount of force necessary to deform the bread after leaving the product on the kitchen table for 2 min following the microwave cooking;
^{c} Toughness is evaluated by 2-3 bites to the product after leaving the product on the kitchen table for 2 min following the microwave cooking.

While certain embodiments of the present invention have been described, other embodiments may exist. After reading the description herein, various aspects, embodiments, modifications, and equivalents may suggest themselves to one with ordinary skill in the art without departing from the spirit of the present invention or the scope of the claims.

I claim:

1. A method for making a microwavable bakery product, the method comprising:
a. mixing dough composed of flour, water, yeast, and optionally other ingredients;
b. portioning and making up dough to desired sizes, shapes and ornamental designs;
c. fermenting and proofing the dough;
d. Steaming the dough until fully cooked throughout, wherein during steaming, a 1-10% moisture is added into the dough, preferably 1-5% moisture is added;
e. baking the fully cooked dough at high heat for a short time until golden brown, wherein during baking a sealed golden brown colored skin is developed without significant moisture loss; and
f. Freezing the bakery product.

2. The method of claim 1, wherein steaming is conducted at about 212° F. and 1 atm for 4-20 min, preferably 5-15 min, and more preferably 6-12 min.

3. The method of claim 1, wherein baking is conducted at 400-800° F. for 0.5-10 min, preferably at 500-700° F. for 0.5-5 min, and more preferably at 600° F. for 0.5-2 min

4. The method of claim 1, wherein baking comprises conventional oven baking, convectional oven baking, impinge oven baking, Turbochef oven baking or a combination thereof.

5. Frozen bakery products produced using method of claim 1, including but not limiting to bread, loaves, pound bread, mini bread, flat bread, bagels, croissants, buns, rolls, sandwiches buns, hamburger buns, hot dog buns, Ciabatta, Focaccia, and the like.

6. A method for making a microwaved bakery product, the method comprising:
a. mixing dough composed of flour, water, yeast, and optionally other ingredients;
b. portioning and making up the dough to desired sizes, shapes and ornamental designs;
c. fermenting and proofing the dough;
d. steaming the dough until fully cooked throughout, wherein during steaming, a 1-10% moisture is added into the dough, preferably 1-5% moisture is added;
e. baking the fully cooked dough at high heat for a short time until color golden brown, wherein during baking a sealed golden brown colored skin is developed without significant moisture losses;
f. freezing the bakery product; and
g. microwaving the bakery product.

7. Microwaved bakery products produced using method of claim 6, include but are not limited to bread, loaves, pound bread, mini bread, flat bread, bagels, croissants, buns, rolls, sandwiches buns, hamburger buns, hot dog buns, Ciabatta, Focaccia, and the like.
